(19) United States
(12) Patent Application Publication
(10) Pub. No.: US 2025/0139581 A1
(43) Pub. Date: May 1, 2025

(54) PREDICT AND MANAGE IMPROVISATION IN CONSTRUCTION SITES FOR ENHANCING SAFETY RISK ASSESSMENT

(71) Applicant: SAUDI ARABIAN OIL COMPANY, Dhahran (SA)

(72) Inventors: Bashar Altakrouri, Dhahran (SA); Ali Abusnina, Dhahran (SA)

(73) Assignee: SAUDI ARABIAN OIL COMPANY, Dhahran (SA)

(21) Appl. No.: 18/498,726

(22) Filed: Oct. 31, 2023

(51) Int. Cl. G06Q 10/10; G06Q 50/08

(52) U.S. Cl. CPC G06Q 10/103; G06Q 50/08

(57) ABSTRACT

A method to facilitate a construction project is disclosed. The method includes obtaining contract data of the construction project, the contract data including information of a contractor, a construction contract, a construction site, and construction activities of the construction project, obtaining, based on the contract data, historical data related to the construction project to form a training dataset, training, using the training dataset, machine learning (ML) models, generating, using the contract data as input to the ML models, insight data of the construction project, generating a contractor improvisation index by aggregating the insight data, and facilitating, based on the contractor improvisation index, the construction project.

### BACKGROUND

Improvisation is defined as actions or behavior conducted by the contractor or their workers in a large construction site as a shortcut that deviates from planned processes and imposed working guidelines. Improvisation is a spontaneous and impulsive, but rational, decision-making process. Improvisation is common if not unavoidable at construction sites because it helps address emerging nonstandard issues or unexpected problems. However, the results of improvisation may lead to hazardous conditions or safety issues of the construction sites.

### SUMMARY

In general, in one aspect, the invention relates to a method to facilitate a construction project. The method includes obtaining contract data of the construction project, the contract data comprising information of a contractor, a construction contract, a construction site, and construction activities of the construction project, obtaining, based on the contract data, historical data related to the construction project to form a training dataset, training, using the training dataset, a plurality of machine learning (ML) models, generating, using the contract data as input to the plurality of ML models, a plurality of insight data of the construction project, generating a contractor improvisation index by aggregating the plurality of insight data, and facilitating, based on the contractor improvisation index, the construction project.

In general, in one aspect, the invention relates to a construction control system to facilitate a construction project. The construction control system includes a computer processor, and memory storing instructions, when executed by the computer processor, comprising functionalities for obtaining contract data of the construction project, the contract data comprising information of a contractor, a construction contract, a construction site, and construction activities of the construction project, obtaining, based on the contract data, historical data related to the construction project to form a training dataset, training, using the training dataset, a plurality of machine learning (ML) models, generating, using the contract data as input to the plurality of ML models, a plurality of insight data of the construction project, generating a contractor improvisation index by aggregating the plurality of insight data, and facilitating, based on the contractor improvisation index, the construction project.

In general, in one aspect, the invention relates to a construction site that includes an oil and gas facility under construction by a construction project, and a construction control system comprising functionalities for obtaining contract data of the construction project, the contract data comprising information of a contractor, a construction contract, the construction site, and construction activities of constructing the oil and gas facility, obtaining, based on the contract data, historical data related to the construction project to form a training dataset, training, using the training dataset, a plurality of machine learning (ML) models, generating, using the contract data as input to the plurality of ML models, a plurality of insight data of the construction project, generating a contractor improvisation index by aggregating the plurality of insight data, and facilitating, based on the contractor improvisation index, the construction of the oil and gas facility.

Other aspects and advantages will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a system in accordance with one or more embodiments.

FIG. 2 shows a flowchart in accordance with one or more embodiments.

FIGS. 3A and 3B show an example in accordance with one or more embodiments.

FIG. 4 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments of this disclosure provide a method and a system to facilitate control in a construction project. The method includes obtaining contract data of the construction project including information of a contractor, a construction contract, a construction site, and construction activities of the construction project. Based on the contract data, historical data related to the construction project is obtained to form a training dataset. Using the training dataset, multiple machine learning (ML) models of a construction control system are trained using ML techniques. Using the contract data as input to the ML models, multiple sets of insight data of the construction project are generated. Accordingly, a contractor improvisation index is generated by aggregating the multiple sets of insight data to facilitate the construction project.

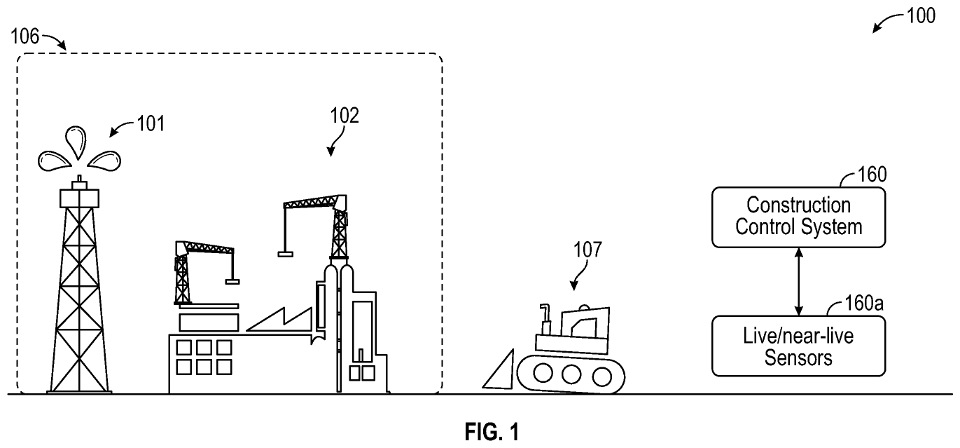

FIG. 1 shows a schematic diagram in accordance with one or more embodiments. As shown in FIG. 1, a construction site (100) includes facility (106) under construction, a contractor (107), and a construction control system (160) equipped with live and/or near-live sensors (160a). In particular, the construction of the facility (106) is referred to as the construction project while the location undergoes the construction project is referred to as the construction site. For example, the construction site (100) and the construction control system (160) may relate to constructing a rig (101) in the oil and gas industry. In other examples, the construction site (100) and the construction control system (160) may equally apply to other types of construction project (e.g., pipeline, processing plant) in the oil and gas industry and/or any other industries, such as manufacturing, energy (e.g., nuclear, solar, wind, hydropower), chemical, infrastructure (bridges, highways, buildings), transportation (automotive, railways), maritime, building construction, aerospace, etc.

In the example shown in FIG. 1, the facility (106) (e.g., rig (101), building (102)) is constructed and/or installed by a construction team of workers such as employees of an oversight entity (e.g., an oil and gas company) of the construction project or workers managed by a third party contractor hired by the oversight entity. In this context, the construction team of employee workers is referred to as an in-house contractor. The oversight entity is a business entity that has commissioned the construction project and contracted the contractor (107). Throughout this disclosure, the in-house contractor and the third party contractor are collectively referred to as the contractor (107). As shown in FIG. 1, the rig (101) is the machine used to drill a borehole to form a wellbore (not shown). The building may be an office building, a residential building, a factory building, a warehouse, a processing plant, etc. that includes single or multiple stories, partitions, utility structures, ventilation duct structures, storage structures, conveyor, elevator, machinery, etc. Major components of the rig (101) include the drilling fluid tanks, the drilling fluid pumps (e.g., rig mixing pumps), the derrick or mast, the draw works, the rotary table or top drive, the drill string, the power generation equipment and auxiliary equipment. From time to time during construction of the many components of the rig (101) and/or building (102), the contractor (107) may improvise and deviate from planned processes and imposed working guidelines, e.g., specified in a construction contract of the oversight entity and the contractor (107). In particular, the oversight entity operates the construction control system (160) to facilitate the construction project, including but not limited to prevent hazardous conditions or safety issues.

In one or more embodiments, the construction control system (160) includes hardware and/or software with functionality for facilitating various aspects of constructing the well system (106). For example, the construction control system (160) may continuously and proactively generate predictions of the tendency of the contractor to improvise during construction of the well system (106). In addition, the construction control system (160) may automatically suggest control measures to mitigate the risks associated with the anticipated improvised actions (i.e., improvisations) of the contractor. Throughout this disclosure, the term “improvisation” refers to an action or behavior conducted by the contractor as a shortcut that deviates from planned process and imposed working guidelines of the construction site. In some embodiments, the construction control system (160) is equipped with live and/or near-live sensors (160a) that generates sensor outputs to facilitate the prediction of the contractor improvisation. For example, worker's location sensors and heavy machinery location sensors are used to reveal the density of certain locations within the construction site. Increased density of workers and machinery, beyond the allowed guidelines and measures, may indicate violations of safety. Using movement tracking sensors of workers and machinery generate data about the flow of workers and machinery within certain locations in the site which also may indicate safety issues in case of abnormal mobilization of workers and machinery. The live and/or near-live sensors (160a) may be coupled to the construction control system (160) via an Internet-of-Things (IoT) network and referred to as IoT sensors. The predicted tendency of contractor to improvise is quantified as an improvisation index. The improvisation index is calculated to represent the risks associated with the predicted improvisations by the contractor. In one or more embodiments, the construction control system (160) calculates the improvisation index of the construction site (100) based on machine learning (ML) techniques to proactively identify, report and manage early indicators of potential improvisations that lead to safety violations. Accordingly, high safety behaviors are enforced to guard personnel and assets.

Machine learning (ML), broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning (ML), or machine-learned, will be adopted herein, however, one skilled in the art will recognize that the concepts and methods detailed hereafter are not limited by this choice of nomenclature.

Machine-learned model types may include, but are not limited to, k-means, k-nearest neighbors, neural networks, logistic regression, random forests, generalized linear models, and Bayesian regression. Also, machine-learning encompasses model types that may further be categorized as “supervised”, “unsupervised”, “semi-supervised”, or “reinforcement” models. One with ordinary skill in the art will appreciate that additional or alternate machine-learned model categorizations may be defined without departing form the scope of this disclosure. Machine-learned model types are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a model is referred to as selecting the model “architecture.”

A cursory introduction to a few machine-learned models and the general principles related to training a supervised machine-learned model are provided below. However, while descriptions of machine-learned models are provided to aid in understanding, one with ordinary skill in the art will recognize that these descriptions do not impose a limitation on the instant disclosure. This is because one with ordinary skill in the art will appreciate that, due to the depth and breadth of the field, a detailed description of the field of machine learning, and the various model types encompassed by the field, cannot be adequately summarized in the present disclosure.

In machine learning, algorithms are trained to find patterns and correlations in large training data sets and to make the best decisions and predictions based on that analysis. Machine learning algorithms build a model based on sample data, known as training data, in order to make predictions or decisions without being explicitly programmed to do so. A training data set is a dataset of examples used during the learning process to fit the parameters of machine learning algorithms, such as weights of a classifier.

Artificial neural networks (ANNs) are a subset of machine learning in deep learning algorithms. The ANN includes node layers, i.e., an input layer, one or more hidden layers, and an output layer. Each node connects to another node and has an associated weight and threshold. If the output of any individual node is above the specified threshold value, that node is activated, sending data to the next layer of the network. Otherwise, no data is passed along to the next layer of the network. ANNs rely on training data to learn and improve their accuracy over time. A convolutional neural network (CNN) is a class of ANN most commonly applied to analyze visual imagery. CNNs use a mathematical operation called convolution in place of general matrix multiplication in at least one of their layers. CNNs are specifically designed to process pixel data and are used in image recognition and processing.

Based on the foregoing, the construction control system (160) generates an explainable improvisation index, highlights potential leading root causes, suggests corrective controls, and enhances associated processes by utilizing the following functionalities a) through g) based on ML techniques.
a) Modelling and analyzing historic data using machine learning and deep learning techniques to predict potential safety violations and to identify potential sources/triggers of these violations. The historical data includes recorded violations and incidents related to the contractor and other recorded characteristics such as the safety index and performance of the contractor's previous projects.
b) Modelling and analyzing historic data using machine learning and deep learning techniques to predict potential safety violations and to identify potential sources/triggers of these violations. The historic data includes recorded violations and incidents related to the construction project and other recorded characteristics such as the construction project's planned activities, mechanical completion certification (MCC), exception item list (EIL), project timeline, Project Safety Index (PSI), etc.
c) Acquiring and analyzing any contextual data (e.g., relating to environment, personnel, and assets) from the construction site's digital twin and Internet of Things (IoT) sensors. The digital twin is a digital representation of the construction site and the IoT sensors are live and/or near-live sensors of the construction control system (160)
d) Mining for relevant insights regarding performance and compliance related to the operational processes and workflows (i.e., executional paths) of the construction project, through predictive and prescriptive process mining.
e) Identifying and predicting potential risks of deviations (based on project scope, description, deliverables, etc.), through fine-tuned large language models (fine-tuned on project and contract documents).
f) Generating explanations of all predicted deviations, identifying their sources, and suggesting process improvements by building automated process improvement powered by artificial intelligence (AI) algorithms, through causal process mining.
g) Generating control measures and recommended mitigations based on AI-powered recommendation system to proactively prevent incidents that may result from the potential violations.

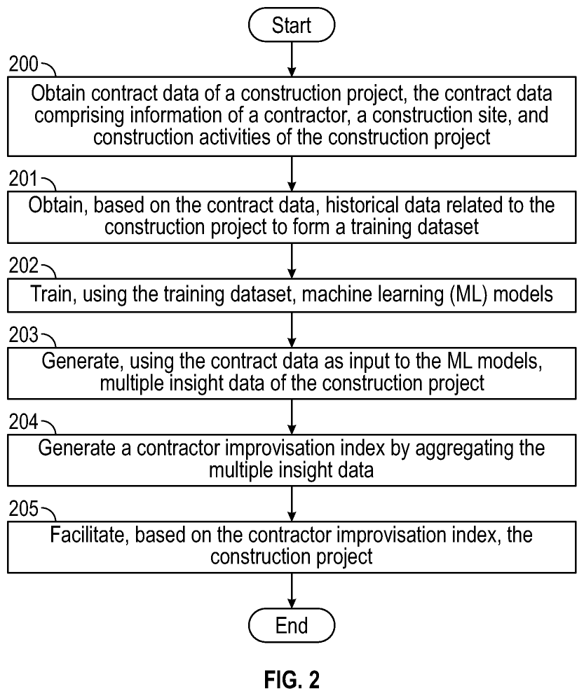

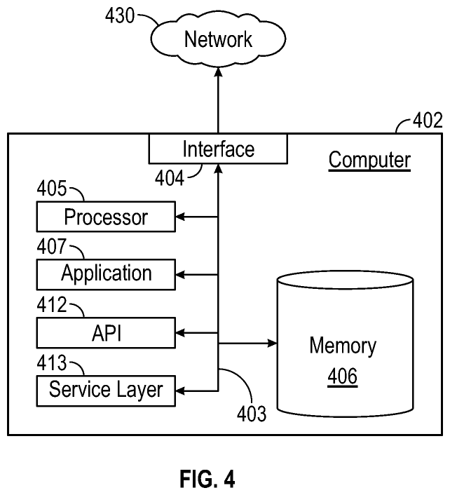

In one or more embodiments, the construction control system (160) performs these functionalities using the method described in reference to FIG. 2 below. In some embodiments, the construction control system (160) includes a computer system, such as a portion of the computing system described in reference to FIG. 4 below. While the construction control system (160) is shown as at the construction site (100), in some embodiments the construction control system (160) may also be away from any construction sites.

Turning to FIG. 2, FIG. 2 shows a process flowchart in accordance with one or more embodiments. FIG. 2 may be performed using one or more components as described in FIG. 1. While the various blocks in FIG. 2 are presented and described sequentially, one of ordinary skill in the art will appreciate that some or all of the blocks may be executed in a different order, may be combined or omitted, and some or all of the blocks may be executed in parallel and/or iteratively. Furthermore, the blocks may be performed actively or passively.

Initially in Block 200, contract data of a construction project is obtained. The contract data includes information of a contractor, a construction contract, a construction site, and construction activities of the construction project. In one or more embodiments, the construction project includes constructing an oil and gas facility, such as a well system, a pipeline network, a processing plant, etc. In other embodiments, the construction project includes constructing facilities for other industries, such as manufacturing, energy (e.g., nuclear, solar, wind, hydropower), chemical, infrastructure (bridges, highways, buildings), transportation (automotive, railways), maritime, building construction, aerospace, etc.

In Block 201, historical data related to the construction project is obtained based on the contract data. The historical data is used to form a training dataset for training machine learning (ML) models for a construction control system. The historical data includes historical incident data of the contractor and related historical construction projects as well as historical contract data of the related historical construction projects. The historical incident data includes incidents of violations or other anomalies in safety practice recorded for previous construction projects that were performed by the contractor or were similar to the current construction projects. In one or more embodiments where live and/or near-live sensors are disposed at the construction site, the historical data further includes historical sensor data of the related historical construction projects that are also included in the ML training dataset.

In Block 202, multiple machine learning (ML) models of the construction control system are trained using the training dataset.

In Block 203, multiple sets of insight data of the construction project are generated using the contract data as input to the multiple ML models. In one or more embodiments, these sets of insight data include incidents insights from the related historical construction projects, contextual insights from sensor data of the construction site, and contractual insights from the construction contract. In particular, the incidents insights, the contextual insights, and the contractual insights are respectively generated by an incidents model, a contextual model, and a large language model (LLM) of the ML models of the construction control system.

In Block 204, a contractor improvisation index is generated by aggregating the multiple sets of insight data. The following example formula of the improvisation index is based on timeboxed lookahead planned construction activities in the site:

$$Improvisation Index = \frac{\sum ( Weighted IPCA )}{\begin{matrix}\sum ( Weighted PCA ) \\ \begin{matrix}where \\ PCA ( Planned Construction Activity ) \\ IPCA ( Improvised Construction Activity )\end{matrix}\end{matrix}} * 10$$

$$Weighted PCA = \sum ( ω ( PCA 0 ) + ω ( PCA 1 ) + … + ω ( PCA n ) ) = 100$$

$$Weighted IPCA = \sum ( ω ( PCA 0 ) * CF ( PCA 0 ) + … + ω ( PCA n ) * CF ( PCA n ) ) = 100$$

$$where$$

$$Weight function ( ω )$$

$$= weight of the activity calculated based factors such as safety critically , required effort or importance$$

$$Classification Function ( CF )$$

$$= classification of an activity to be susceptible to improvisation ( e . g . , using Binary Logistic regression )$$

Those skilled in the art will appreciate that the above formula is only one example and may be changed according to the business needs and the domain. Moreover, other more complicated formulas may also include other factors such as the probabilities of improvisation for each activity as well.

In Block 205, the construction project is facilitated based on the contractor improvisation index. In one or embodiments, the contractor improvisation index is presented to a user using a construction control dashboard. In one or embodiments, an alert is sent to a user in response to the contractor improvisation index exceeding a pre-determined threshold. Accordingly, a mitigation action of the construction project is initiated by the user in response to the alert. Mitigation actions may include reduction of the work force density or the heavy machinery density within a certain location; enforcing a Stop Work on the site; or increasing the number of flag men (workers guiding heavy machinery) in the site.

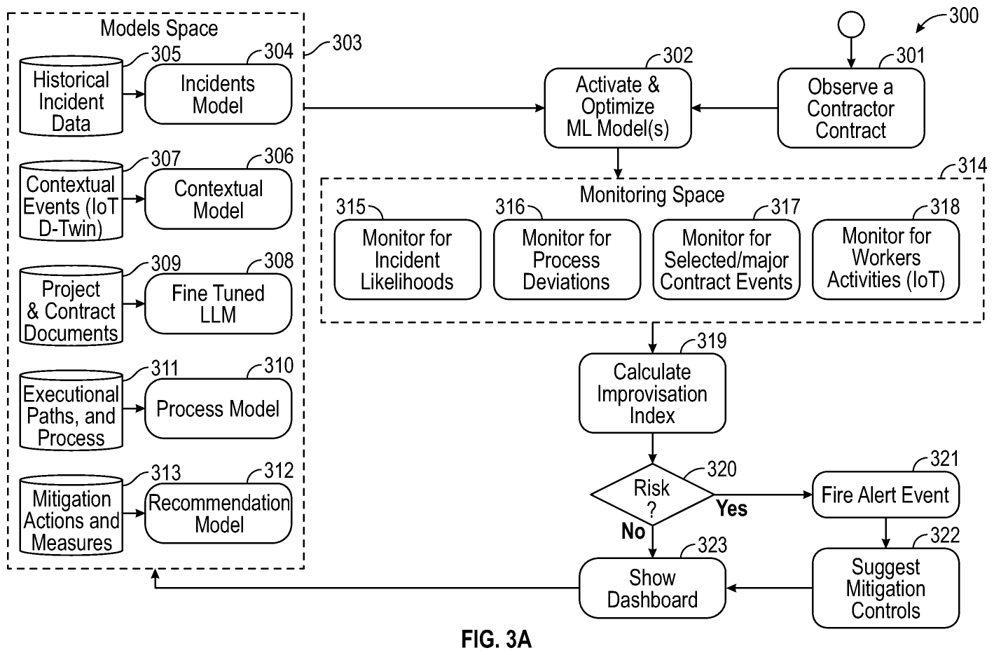

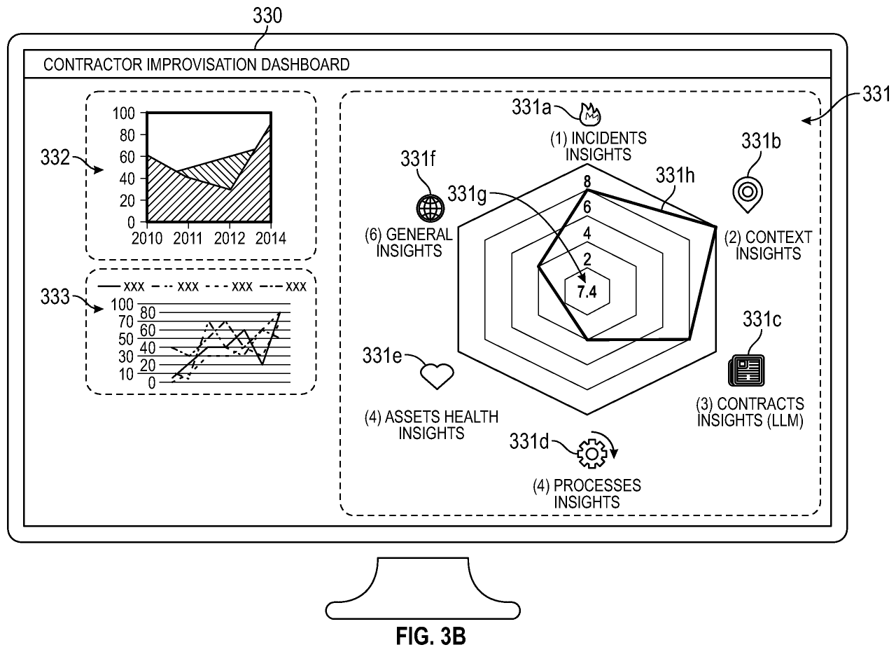

FIGS. 3A and 3B show an example in accordance with one or more embodiments. The example shown in FIGS. 3A and 3B is based on the system and method described in reference to FIGS. 1 and 2 above. In one or more embodiments, one or more of the modules and/or elements shown in FIGS. 3A and 3B may be omitted, repeated, combined and/or substituted. Accordingly, embodiments disclosed herein should not be considered limited to the specific arrangements of modules and/or elements shown in FIGS. 3A and 3B.

FIG. 3A shows a workflow (300) of the construction control system (160) for generating and presenting the contractor improvisation index. In step (301), a certain contract is selected to be observed for improvisation actions by the contractor. For example, the contract is an agreement document (e.g., paper document or digital document) for the construction project to be performed by the contractor. In step (302), a Machine Learning (ML) module within the construction control system (160) for calculating the index is activated and optimized based on the type or other characteristics of the selected contract, planned activities, hazard plan and implementation timeline. For example, the ML module may include software and/or hardware components that execute ML algorithms. This step relies on a Models Space (303) within the construction control system (160) that is built on top of five ML models each covers an important aspect related to the improvisation index. For example, the Models Space (303) may be a data repository included in or accessible by the construction control system (160). The Incidents Model (304) is a ML model that is trained on historical incident data (305) relating to prior minor safety incidents, major safety incidents, safety observations, improvisation actions, etc. of the contractor. The Contextual Model (306) is a ML model that is trained on historical contextual data (307) based on the digital twin (i.e., a digital representation) and IoT data of previous related construction projects. IoT data may include data about the health of heavy machinery, workers locations, workers flow of movements, construction status, etc. The Fine-Tuned Large Language Model (308) is a Large Language Model (LLM) that is fine-tuned based on a large set of documents (309) related to projects, contracts and other documents available inside or outside the organization knowledge base such as job safety analysis documents, safety related articles, safety briefing documents, etc. of the selected contract. The Process Minor (310) model models the construction projects' processes and executional paths (311). The Recommendation Model (312) is an ML model that is trained on historical and general instruction data relating to prior incidents mitigations and control measures (313). The activated ML models collectively form the core intelligence for all monitoring activities recorded in the monitoring space (314), which is a data repository included in or accessible by the construction control system (160). The recorded monitoring data in the monitor space (314) relates to monitoring for incidence likelihood (315), process deviations (316), contract events (317) and workers activities (318).

The following shows an exemplary data structure of the incident likelihood monitoring data (315). The data structure shows some metadata about the potential incidents for a particular contract, process, location (e.g., the rig) and type of the construction type. Moreover, the data structure shows the output of the potential incidents including the incident count and a detailed view over the expected potential incidents. In this detailed view, each incident is given an id, incident type (e.g., safety related), severity (e.g., high), confident of the ML inference (e.g., high for I-001 and medium for I-002), the confidence of this inference and finally a description of the incidents.

```
‘{
“contract_id:“CN-10012”,
“process_id:“PR-4543210”,
“location”:“Rig-DH-002/Z001”,
“construction_type”:“rig-construction”,
“output”:
  {
    “incident_count”:“6”,
    “incidents_view”:
    {
      {
      “incident_id”:“I-001”,
      “incident_type”:“safety”,
      “severity ”:“High”,
      “confidence ”:“67%”,
      “working_zone”:“Rig-DH-002/Z001-S002”,
      “incident_description”:“Working in small proximity to
      heavy machines”,
      },
      {
      “incident_id”:“I-002”,
      “incident_type”:“safety”,
      “severity ”:“Medium”,
      “confidence ”:“92%”,
      “working_zone”:“Rig-DH-002/Z001-S002”,
      “incident_description”:“Working in small proximity to
      other workers”,
      },
      {
      “incident_id”:“I-003”,
      “incident_type”:“safety”,
      “severity ”:“High”,
      “confidence ”:“63%”,
      “working_zone”:“Rig-DH-002/Z001-S002”,
      “incident_description”:“Working at hight”,
      },
      . . .
    }
  }
}
```

The following shows an exemplary data structure of the process deviations monitoring data (316), data for tracking the execution sequence of constriction activities may have the following simplified data structure. This example shows starts with meta information about process such as the process id, location, and the type of this process (e.g., a two week lookahead schedule tracker). The output of this data structure shows the detected deviation which is related to 11th step of a sequential process. The deviation impact is high. The cause of this deviation can be seen in the deviation detailed view where this step was skipped and not executed according to the sequence.

```
‘{
“process_id:“PR-4543210”,
“location”:“Rig-DH-002/Z001”,
“type”:“two-week-process-tracker”,
“output”:
  {
    “process_steps”:“9”,
    “process_type”:“sequential”,
    “deviation”:“true”,
    “deviation_type”:“sequence”,
    “severity”:“high”,
    “deviation_view”:
    {
      {
      “step_id”:“PR-4543210/005”,
      “execution_details”:“skipped”,
      },
      . . .
    }
  }
}
```

The following shows an exemplary data structure of the major contract events data (317), data for tracking the major contract events or milestones may have the following simplified data structure. This example shows starts with meta information about the contract such as its id, target location, and type of the activity (e.g., rig construction). The output of this data structure shows the number of major events within for this contract and the order of these events (e.g., sequence). Moreover, in the detailed event view, the events are listed with their id, completion date and a short description about the milestone.

```
‘{
“contract_id:“CN-10012”,
“location”:“Rig-DH-002/Z001”,
“type”:“rig-construction”,
“output”:
  {
    “major_events_count”:“4”,
    “event_order”:“sequence”,
    “event_view”:
    {
      {
      “event_id”:“001”,
      “schedule_date”:“01/11/2024”,
      “event_description”:“1^{st} project kickstart”,
      },
      {
      “event_id”:“002”,
      “schedule_date”:“15/12/2024”,
      “event_description”:“1^{st} construction signoff”,
      },
      . . .
    }
  }
}
```

The following shows an exemplary data structure of the workers activities monitoring data (318), IoT data for tracking workers' locations may have the following simplified data structure from one of the IoT sensors in the facility. The data structure shows some metadata about the sensors such as its id, type and location. Moreover, the data structure shows the output of the sensor which starts with the workers' and equipment's′ total count that the sensor detected. It also shows detailed information about the works (e.g., their id, names and their current working zones). Moreover, it shows the detailed information about the equipment detected with their id, name and working zones. Based on this information, an incident likelihood percentage is inferenced (e.g., incident likelihood=92%) alongside the confidence of this ML inferred value (confidence=97%).

```
‘{
“sensor_id:“sn-ert450210”,
“location”:“Rig-DH-002/Z001”,
“type”:“asset-worker-tracker”,
“output”:
  {
    “worker_count”:“19”,
    “equipment_count”:“12”,
    “workers_view”:
    {
      {
      “worker_id”:“AD-0210”,
      “worker_name”:“John”,
      “working_zone”:“Rig-DH-002/Z001-S002”,
      },
      . . .
    },
    “equipment_view”:
    {
      {
      “equipment_id”:“EF-XD01A”,
      “equipment_name”:“Driller11-AR025”,
      “working_zone”:“Rig-DH-002/Z001-S002”,
      },
      . . .
    }
  }
}
```

Live or near-live events related to workers activities, precursor analysis (which considers the conditions of the workers) and equipment activities are also monitored and recorded for a more complete contextual and situational picture around the contract and its processes. For example, workers' mental and health status may be used as an indicator of higher improvisation. The mobilization of the contractor's equipment in a nearby location may also be considered a contributing factor to potential improvisation.

In step (319), an explainable contractor improvisation index is calculated in a timely manner, which reflects the potential for the contractor to improvise and resort to deviating from planned processes, project safety measures and general instructions. A higher improvisation index indicates higher possibilities for improvisation acts by the contractor and their workers. In step (320), the value and criticality of the improvisation index is evaluated to identify whether any risky improvisation act is imminent. If the improvisation index exceeds a pre-determined threshold, which identifies risky improvisation act, step (321) triggers an alert event to be sent to a user of the construction control system. For example, the user may be an oversight entity of the construction project, such as a manager, supervisor, or other related stakeholders of the oil and gas company. Subsequently in step (322), mitigation controls associated with the alert event are identified and suggested to the user, e.g., the oversight entity. In step (323), the improvisation index and related details are presented to the user via the project management dashboard. An example of the project management dashboard is shown in FIG. 3B below. Any input from the user in response to viewing the improvisation index and related details is sent from the project management dashboard in a feedback loop to the models space (303). The feedback loop ensures that the models in the space (303) are recalibrated, re-learned and re-trained to enhance the performance of the models after each running iteration of the workflow (300) or each alert event.

FIG. 3B illustrates an exemplary construction project dashboard (330) displayed on a computer display device. The construction project dashboard (330) includes an explainable improvisation index window (331) and additional exemplary information windows (332, 333) that show live data about the construction project which could be related to explaining the improvisation index. The window (332) illustrates a placeholder for statistics about the historical safety incidents in similar construction sites and (333) illustrates a placeholder for live IoT data from the construction site such as the different site zones and the density of works in the zone. Having such dashboard windows helps to explain and give some more context about the construction site and its safety. The improvisation index window (331) shows an aggregate index value (331g) of 7.4 and six most relevant contributing insights or factors that influence the current improvisation index value (331a, 331b, 331c, 331d, 331e, 331f). The higher value (331g) of the improvisation index indicates higher probability of the contractor conducting improvised actions (the value 0 indicates no improvisation expected and the value 10 indicates high improvisation expected). (331h) shows the most contributing insights or factors and their weights (i.e., 0 no weight/not relevant to 10 high weight) for the displaced improvisation index (331g). For the current example, the most contributing factors or insights are incidents insights (331a), context insights (331b) and contract insights (331c). The six contributing factors shown are dynamic and may change based on the factors needed to explain the current improvisation index. The first factor, incidents insights (331a), is based on the monitoring space (314) in FIG. 3A which is related to the likelihood of incidents. The second factor, context insights (331b), is based on workers activities in the site (318) in FIG. 3A which is related live or near-live IoT data. The third factor, contracts insights (331c), is based on contractual data and its major events (317) in FIG. 3A. The fourth factor, process insights (331d), is based on process deviations (316) in FIG. 3A. The fifth factor, asset health insights (331e), is based on workers activities in the site (318) in FIG. 3A which is related live or near-live IoT data about the machines and equipment health that the workers use. The sixth factor, general insights (331f), is based on general insights about the contract aggregated from general and external knowledge base from outside the corporate knowledge base (similar project documents, technical reports, etc.).

The improvisation index value (331g) is calculated by aggregating six different modeling results in the models space (303) depicted in FIG. 3A above. There are three main contributing insight factors (331a, 331b, 331c) to this calculation, namely incidents insights (331a) from other projects, contextual insights (331b) gathered from the live and near-live sensors of the construction site such as the density of workers within the working zone and the health of the equipment in use. Moreover, the contractual insights (331c) from the current construction contract and related contracts. On the other hand, process insights (331d), asset health insights (331e), and general insights (331f) have much less impact on the aggregate index value (331g) of the improvisation index. Relating back to FIG. 3A, the incidents insights (331a), contextual insights (331b), contractual insights (331c), process insights (331d), and asset health insights (331e) are modeling results from the incidents model (304), contextual model (306), LLM (308), process model (310), and recommendation model (312), respectively. General insights include any information and data related to the contract and construction activities from any external knowledge base (e.g., knowledge based on the internet) such as any technical report, document or datasets available outside the organization.

The user of the construction control system (160) may still drill down in a more details view of all these types of insights as required. For example, drilling down in the context insights may reveal more information about the teams' locations, the teams' health, zone crowdedness, assets locations, etc. as shown in windows (332, 333).

Embodiments may be implemented on a computer system. FIG. 4 is a block diagram of a computer system (402) used to provide computational functionalities associated with described algorithms, methods, functions, processes, flows, and procedures as described in the instant disclosure, according to an implementation. The illustrated computer (402) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

In some embodiments, the computer (402) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method to facilitate a construction project, comprising:
obtaining contract data of the construction project, the contract data comprising information of a contractor, a construction contract, a construction site, and construction activities of the construction project;
obtaining, based on the contract data, historical data related to the construction project to form a training dataset;
training, using the training dataset, a plurality of machine learning (ML) models;
generating, using the contract data as input to the plurality of ML models, a plurality of insight data of the construction project;
generating a contractor improvisation index by aggregating the plurality of insight data; and
facilitating, based on the contractor improvisation index, the construction project.

2. The method of claim 1, the historical data comprising:
historical incident data of the contractor and related historical construction projects; and
historical contract data of the related historical construction projects.

3. The method of claim 2, further comprising:
obtaining, using one or more sensors disposed at the construction site, sensor data of the construction site,
wherein the historical data further comprises historical sensor data of the related historical construction projects to form the training dataset, and
wherein the sensor data is used as additional input to the plurality of ML models to generate the plurality of insight data of the construction project.

4. The method of claim 3,
wherein the plurality of insight data comprise incidents insights from the related historical construction projects, contextual insights from sensor data of the construction site, and contractual insights from the construction contract, and
wherein the incidents insights, the contextual insights, and the contractual insights are respectively generated by an incidents model, a contextual model, and a large language model (LLM) of the plurality of ML models.

5. The method of claim 1, wherein facilitating the construction project comprises:
presenting, using a construction control dashboard, the contractor improvisation index to a user.

6. The method of claim 1, wherein facilitating the construction project comprises:
sending, in response to the contractor improvisation index exceeding a pre-determined threshold, an alert to a user; and
initiating, by the user in response to the alert, a mitigation action of the construction project.

7. The method of claim 1,
wherein the construction project comprises constructing one of a well system, a pipeline network, and a processing plant.

8. A construction control system to facilitate a construction project, comprising:
a computer processor; and
memory storing instructions, when executed by the computer processor, comprising functionalities for:
obtaining contract data of the construction project, the contract data comprising information of a contractor, a construction contract, a construction site, and construction activities of the construction project;
obtaining, based on the contract data, historical data related to the construction project to form a training dataset;
training, using the training dataset, a plurality of machine learning (ML) models;
generating, using the contract data as input to the plurality of ML models, a plurality of insight data of the construction project;
generating a contractor improvisation index by aggregating the plurality of insight data; and
facilitating, based on the contractor improvisation index, the construction project.

9. The construction control system of claim 8, the historical data comprising:
historical incident data of the contractor and related historical construction projects; and
historical contract data of the related historical construction projects.

10. The construction control system of claim 9, further comprising:
one or more sensors disposed at the construction site that generates sensor data of the construction site,
wherein the historical data further comprises historical sensor data of the related historical construction projects to form the training dataset, and
wherein the sensor data is used as additional input to the plurality of ML models to generate the plurality of insight data of the construction project.

11. The construction control system of claim 10,
wherein the plurality of insight data comprise incidents insights from the related historical construction projects, contextual insights from sensor data of the construction site, and contractual insights from the construction contract, and
wherein the incidents insights, the contextual insights, and the contractual insights are respectively generated by an incidents model, a contextual model, and a large language model (LLM) of the plurality of ML models.

12. The construction control system of claim 8, wherein facilitating the construction project comprises:
presenting, using a construction control dashboard, the contractor improvisation index to a user.

13. The construction control system of claim 8, wherein facilitating the construction project comprises:
sending, in response to the contractor improvisation index exceeding a pre-determined threshold, an alert to a user; and
initiating, by the user in response to the alert, a mitigation action of the construction project.

14. The construction control system of claim 8,
wherein the construction project comprises constructing one of a well system, a pipeline network, and a processing plant.

15. A construction site, comprising:
a facility under construction by a construction project; and
a construction control system comprising functionalities for:
obtaining contract data of the construction project, the contract data comprising information of a contractor, a construction contract, the construction site, and construction activities of constructing the facility;
obtaining, based on the contract data, historical data related to the construction project to form a training dataset;
training, using the training dataset, a plurality of machine learning (ML) models;
generating, using the contract data as input to the plurality of ML models, a plurality of insight data of the construction project;
generating a contractor improvisation index by aggregating the plurality of insight data; and
facilitating, based on the contractor improvisation index, the construction of the facility.

16. The construction site of claim 15, the historical data comprising:
historical incident data of the contractor and related historical construction projects; and
historical contract data of the related historical construction projects.

17. The construction site of claim 16, the construction control system further comprising:
one or more sensors disposed at the construction site that generates sensor data of the construction site,
wherein the historical data further comprises historical sensor data of the related historical construction projects to form the training dataset, and
wherein the sensor data is used as additional input to the plurality of ML models to generate the plurality of insight data of the construction project.

18. The construction site of claim 17,
wherein the plurality of insight data comprise incidents insights from the related historical construction projects, contextual insights from sensor data of the construction site, and contractual insights from the construction contract, and
wherein the incidents insights, the contextual insights, and the contractual insights are respectively generated by an incidents model, a contextual model, and a large language model (LLM) of the plurality of ML models.

19. The construction site of claim 15, wherein facilitating the construction project comprises:
presenting, using a construction control dashboard, the contractor improvisation index to a user;
sending, in response to the contractor improvisation index exceeding a pre-determined threshold, an alert to the user; and
initiating, by the user in response to the alert, a mitigation action of the construction project.

20. The construction site of claim 15,
wherein the facility comprises at least one of a well system, a pipeline network, and a processing plant.
